(19) United States
(12) Patent Application Publication
(10) Pub. No.: US 2004/0096596 A1
(43) Pub. Date: May 20, 2004

(54) Christmas tree shaped artificial tree

(76) Inventors: John M. Palmer III, Dallas, TX (US); John M. Palmer JR., Lutz, FL (US); Evelyn C. Martinez, Clearwater, FL (US)

Correspondence Address: John M. Palmer, Jr., P.O. Box 115, Lutz, FL, 33548, US

(21) Appl. No.: 10/631,020

(22) Filed: Jul. 29, 2003

Related U.S. Application Data
(60) Provisional application No. 60/399,144, filed on Jul. 30, 2002.

(51) Int. Cl. A01N 1/00

(52) U.S. Cl. 428/15

(57) ABSTRACT

A Christmas tree shaped artificial tree having a pole for a tree trunk with a plurality of guy wires attached to the top of the pole and extending downwardly and outwardly to the surface on which the pole is disposed. Profile cables are attached to a hoistable sleeve at the top of the pole but under the guy wire attachment. They extend downwardly and outwardly to spreaders radiating from the pole, then back to the pole a distance above the base end of the pole creating a Christmas tree shape. The guy wires may be rotatably attached to the top of the pole, with the base of the pole mounted on a rotating device, if a revolving tree is desired. Christmas tree light strings are suspended between the profile cables and additional hoistable sleeves on the pole to define a branch shaped form.

This application claims the benefit of Ser. No. 60/399,144, filed Jul. 30, 2002.

### BACKGROUND

1. Field of Invention

This invention relates to a Christmas tree comprising a pole for a trunk and strings of lights,

2. Description of Prior Art

Over the years a number of trees have been developed using a pole for the trunk with light strings attached to the top of the pole and extended downwardly and outwardly to the ground to form a conical shape which simulates that of a Christmas tree. Some inventors have used strings of lights in the shape of tree branches such as shown in U.S. Pat. No. 2,289,680 to Prettyman (1942). U.S. Pat. No. 3,704,366 to Korb et al (1972) discloses a system having horizontal spreaders radiating from a trunk pole. U.S. Pat. No. 5,712,002 to Reilly, 111 (1998) discloses a system having a telescopic trunk pole.

### OBJECTS AND ADVANTAGES

Several of the many objects and advantages of the present invention are:

(1) to provide an artificial Christmas tree having a trunk pole that can be erected to its vertical position without the light strings being attached.

(2) to provide an artificial Christmas tree having 3 or more guy wires anchored to the ground for holding the pole in a vertical position.

(3) to provide an artificial Christmas tree having a system for rotatably connecting the guy wires to the top of the pole and for mounting the lower end of the pole on a rotatably designed base for those trees required to be rotated.

(4) to provide an artificial Christmas tree having a system for hoisting and lowering the light strings.

(5) to provide an artificial Christmas tree having a segmented trunk pole if desired.

(6) to provide an artificial Christmas tree having light strings suspended to form a tree branch shape.

### DRAWING FIGURES

In the drawings, closely related figures may have the same number but different alphabetic suffixes.

FIG. 1 shows in an elevation view the tree mounted on a rotating base device and two guy wires attached to screw anchors in the ground.

FIG. 2 shows the tree of the previous FIG. in a smaller scale with encircled areas which are exploded in subsequent FIGS.

FIG. 3 shows the top of the tree pole with the guy wire assembly and sleeve lifting system.

FIG. 4 shows the pole splice connection.

FIG. 5 shows the hoisting lines exiting the pole and a cleat for tying them off.

FIG. 6 shows a sleeve assembly.

FIG. 7 shows the combination spreader and light string sleeve.

FIG. 8 shows the combination profile disc and light string sleeve.

FIG. 9 shows the light string atached to the profile cable.

FIG. 10 shows the outer end of a spreader and the attached light string and profile cable.

FIGS. 11, 12 and 13 show in plan view light socket disc.

FIG. 14 shows the spreader hub.

FIG. 15 shows the profile cable disc.

FIG. 16 shows in plan view the tree.

### REFERENCE NUMERALS IN DRAWINGS

10 tree 20 mounting surface

30 trunk pole and hoisting system 40 guy wire system

50-70 pole sleeves 80 profile cables

90 light strings 100 star

### SUMMARY

In accordance with the present invention the tree comprises a trunk pole, guy wires, profile cables, light strings and a hoisting system for raising and lowering the light strings.

### DISCLOSURE

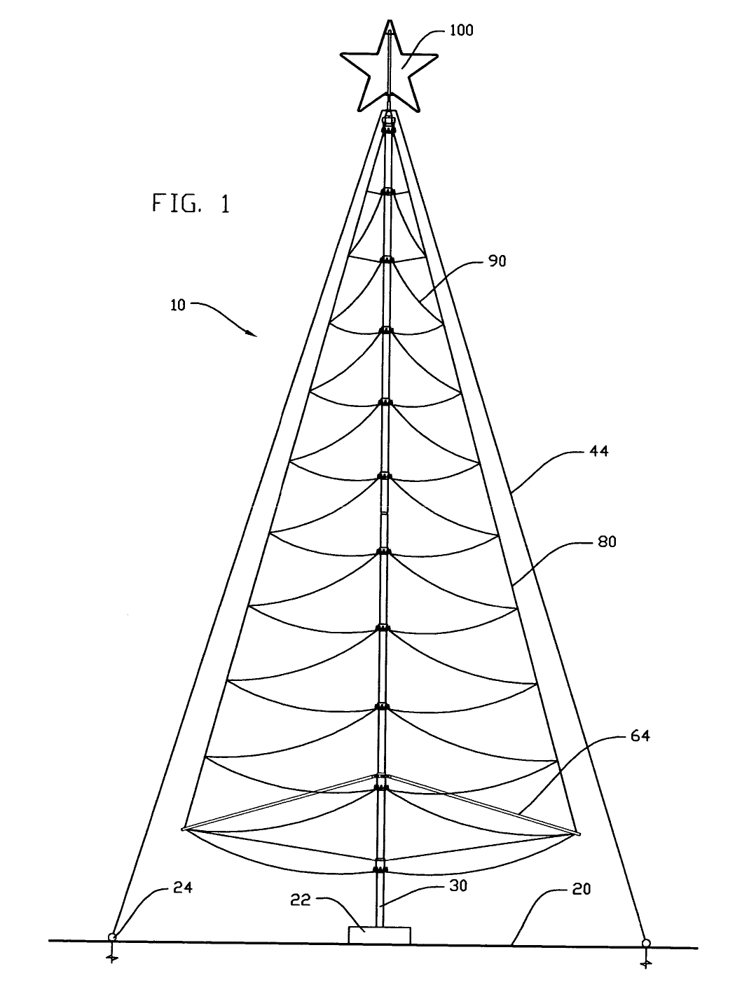

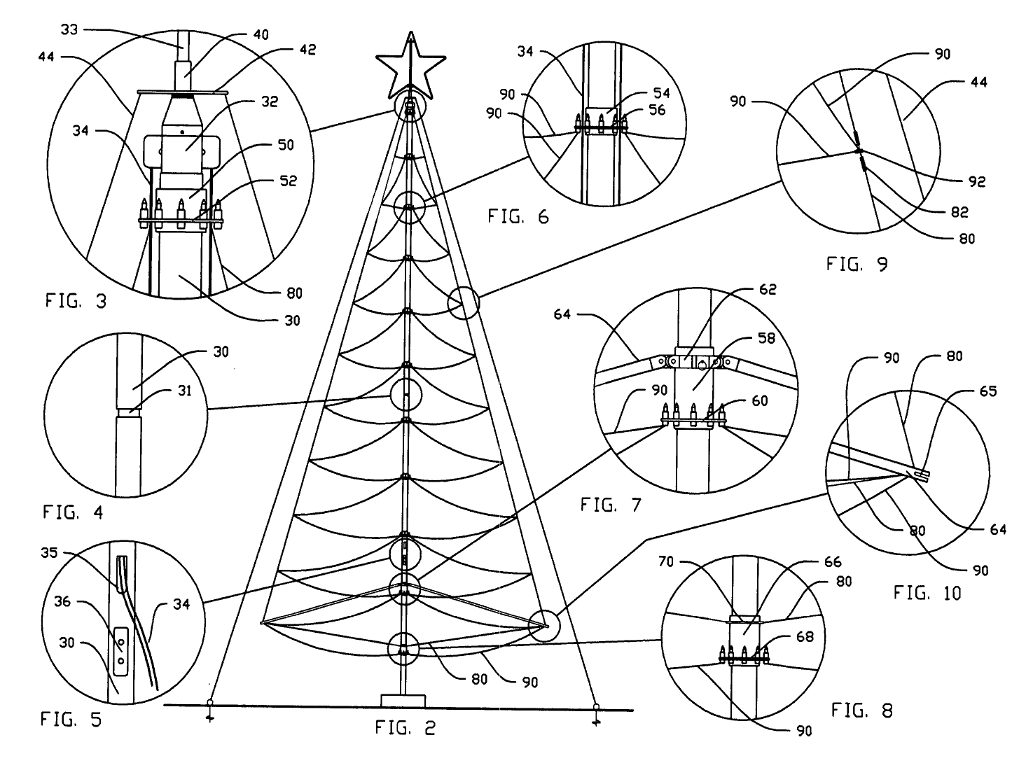

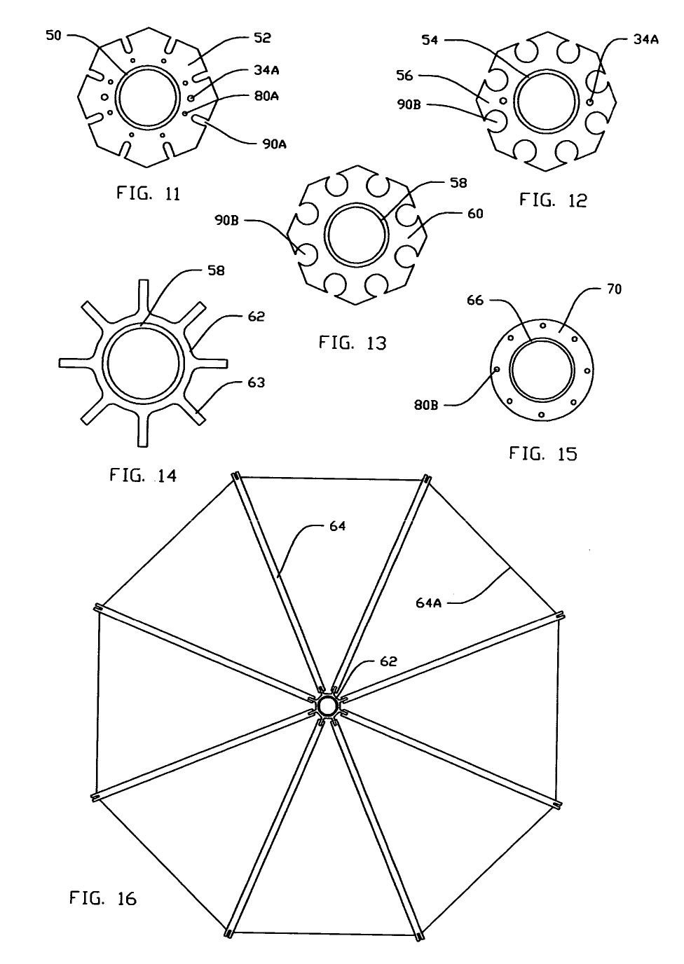

A typical embodiment 10 of the tree of the present invention is illustrated in FIGS. 1 and 2 mounted on a horizontal surface 20 and secured in a vertical position with guy wires 44 attached to screw anchors 24. If it is desired for the tree to rotate, trunk pole 30 would be placed on a rotating device 22. When the trunk pole 30 comprises two or more sections, a cylindrical, tubular connector 31 FIG. 4 must be inserted in the ID of the pole leaving the OD smooth so light socket sleeves 50 and 54 (FIG. 6) are free to be hoisted and lowered by lines 34. The top of pole 30 in FIG. 3 comprises an axle 33 which can rotate in bearing 40 and a sheave assembly 32 for hoisting lines 34. Disc 52 (FIG. 11) is attached to sleeve 50 and to lines 34. The upper ends of the light strings 90 and the upper ends of the profile cables 80 terminate at light socket disc 52. 100 represents an optional star.

In FIG. 5 hoisting lines 34 are shown exiting slot 35. This slot is located at a height convenient for hoisting and lowering the light strings 90. They can be tied off on cleat 36.

In FIG. 6 one of the intermediate light socket sleeves 54 is shown with light string 90 attached to light socket disc 56. Hoisting lines 34 are connected to the sleeves at the vertical interval necessary for the desired tree branch shape to be formed. Sleeve 58 (FIG. 7) and sleeve 66 (FIG. 8) are not connected to the hoisting lines and are demountably fixed to trunk pole 30.

In FIG. 7 spreader hub 62 is shown as part of sleeve 58 with spreaders 64 connected. A light socket disc 56 is also a part of this sleeve.

In FIG. 8 profile cable disc 70 is shown as part of sleeve 66 with profile cables 80 connected. A light socket disc 68 is also a part of this sleeve.

In FIG. 9 light string 90 is shown attached to profile cable 80 with connector 92. Stops 82 keep connector 92 from riding up and down the profile cable.

In FIG. 10 the outer end of spreader 64 is shown with profile cable 80 and light string 90 attached to it. Notch 65 is provided for attaching optional parameter cord 64A (FIG. 16). The cord adds to the overall structural integrity during strong winds.

In FIG. 11 light socket disc 52 is shown in plan view as part of sleeve 50 with orifice 34A for receiving hoisting lines 34, orifice 80A for receiving profile cables 80 and notch 90A for receiving light strings with rectangular shaped light sockets.

FIG. 12 shows light socket disc 56 which is similar to disc 52 minus orifice 80A and with notch 90B for receiving light strings with circular shaped light sockets.

FIG. 13 shows light socket disc 60 which is similar to disc 56 minus orifice 34A.

FIG. 14 shows spreader hub 62 to which spreaders 64 are connected.

FIG. 15 shows profile cable disc 70 to which profile cables 80 are connected.

FIG. 16 shows in plan view a typical embodiment with an eight spreader 64 design and optional parameter cord 64A.

### SUMMARY, RAMIFICATIONS, AND SCOPE

Accordingly, the reader will see that the tree of this invention can be easily installed, that it can be economically produced and marketed. When made of aluminum it is light weight for shipping and can be anodized for long life. Since it can be supported with a minimum of three guy wires, underlying grass can be more easily maintained than those similar to Reillys, U.S. Pat. No. 5,712,002. Furthermore, by being able to raise and lower the light strings easily, an owner does not have to hesitate replacing a single light bulb. If the rotating feature is desired later, the tree can easily be placed on the optional rotating system.

Although the description above contains many specifications, these should not be construed as limiting the scope of the invention but as merely providing illustrations of some of the presently preferred embodiments of this invention. For example, the sleeves and light socket disc could be molded as a single unit, the spreader hub could be an extrusion, etc.

Thus the scope of the invention should be determined by the appended claims and their legal equivalents, rather than by the examples given.

We claim:

1. A Christmas tree shaped artificial tree, comprising:
a vertical trunk pole having a top end and a bottom end, the top end configured to receive guy means, the bottom end configured to reside on the ground and other surfaces;
a plurality of guy wires attach to the guy means at said top end of said trunk pole and extend to surface anchor means;
hoisting means on said top end of said trunk pole allow for hoisting lines to attach to hoistable light string sleeves, which traverse the OD of said trunk pole, then travel over the hoisting means to the inside of said trunk pole then down said trunk pole to an opening in said trunk pole where the hoisting lines exit said trunk pole, said hoisting lines can then be pulled to raise the hoistable light string sleeves and released to lower said hoistable light string sleeves, said hoistable light string sleeves are attached to said hoisting lines a distance from each other required for forming a simulated tree branch;
a combination fixed light string and spreader hub sleeve, preferably located vertically approximately the same height as the height at the greatest diameter of said tree, the spreader hub receives spreaders which hold profile cables a desired distance from said trunk pole to give the tree the Christmas tree shape;
a combination fixed light string and profile cable disc sleeve, the profile cable disc receives the profile cables near the lower end of said trunk pole subsequent to their connecting to the outer end of the spreaders to give said tree the lower part of the Christmas tree shape;
a plurality of profile cables attach to the uppermost hoistable light string sleeve and extend downwardly and outwardly to the outer end of said spreaders then back to the lower end of said trunk pole;
a plurality of light strings extendable intermediate desired light string sleeves and desired profile cables at desired positions.

2. A Christmas tree shaped artificial tree as described in claim 1, wherein said trunk pole may comprise several sections connected with tubular sections inserted in the ID of said trunk pole.

3. A Christmas tree shaped artificial tree as described in claim 1, wherein said guy means is rotatably mounted to said top end of said trunk pole allowing said tree to rotate when said bottom end of said trunk pole is mounted on a rotating drive system.

4. A Christmas tree shaped artificial tree as described in claim 1, wherein said top end of said trunk pole has a shaft on which said guy means is mounted, the shaft may also provide for attaching a star which will rotate when said tree rotates.

5. A Christmas tree shaped artificial tree as described in claim 4, further including the star.

6. A Christmas tree shaped artificial tree as described in claim 1, wherein the combination fixed light string and spreader hub sleeve are not combined but are individual sleeves.

7. A Christmas tree shaped artificial tree as described in claim 1, wherein the combination fixed light string and profile cable disc sleeve are not combined but are individual sleeves.

8. A Christmas tree shaped artificial tree as described in claim 1, wherein the plurality of light strings may include decorative ornaments rather than light bulbs.

9. A Christmas tree shaped artificial tree as described in claim 8, wherein the plurality of light strings may include a combination of decorative ornaments and light bulbs.

10. A Christmas tree shaped artificial tree as described in claim 1, wherein all parts may be composed of metals, plastics and organic materials.
